(19) United States
(12) Patent Application Publication
(10) Pub. No.: US 2005/0033961 A1
(43) Pub. Date: Feb. 10, 2005

(54) Method and apparatus for scrambling cell content in an integrated circuit

(75) Inventor: Alain Vergnes, Trets (FR)

Correspondence Address: SIERRA PATENT GROUP, LTD., P O BOX 6149, STATELINE, NV, 89449, US

(73) Assignee: Atmel Corporation, a Delaware Corporation

(21) Appl. No.: 10/861,683

(22) Filed: Jun. 4, 2004

(30) Foreign Application Priority Data
Aug. 9, 2003 (FR) 03 08405

(51) Int. Cl. H04L 9/00; H04N 7/167

(52) U.S. Cl. 713/170

(57) ABSTRACT

The invention provides a system for scrambling data in a sequential cell. The sequential cell is configured to receive the data from a data bus. A scrambling unit is coupled to the sequential cell and the data bus. The scrambling unit is configured to receive a scrambling unit input from the data bus and produce a scrambling unit output that differs from the scrambling unit input. The scrambling unit output is transmitted to the sequential cell. A descrambling unit is coupled to the sequential cell and is configured to receive a descrambling unit input from the sequential cell and produce a descrambling unit output that differs from the descrambling unit input. The descrambling unit output is equal to the scrambling unit input.

### CROSS-REFERENCE TO RELATED APPLICATIONS

This application claims priority to French Application Serial Number 03 08405, filed Aug. 9, 2003.

### BACKGROUND OF THE INVENTION

1. Field of the Invention

The invention relates generally to sequential logic cell content and specifically to protecting register content in microcontrollers.

2. The Prior Art

Integrated circuits (ICs) are typically tested for defects arising out of fabrication, and one of the tests used is a scan test. One problem with ICs is protecting sensitive register content. Registers may be comprised of sequential logic cells and each sequential logic cell is scannable. Scan methods are very efficient but provide an easy means of seeing the logical values of many nets or registers of the IC. Downloading the content of each register using the scan test is possible after a period of operation for the circuit. A problem occurs when some of the register contains sensitive information from, for example, crypt algorithm keys or parameters for special digital filters or other value to be more or less protected.

In some applications, for example secure microcontrollers and smart cards, scan tests are not available or they use scan methods combined with built-in scan vector generators and signature analyzer modules so that nothing can be downloaded from the pins of the ICs but defects may be found even if scan chain inputs and outputs do not appear on the top-level pin of the circuit.

For on-chip and off-chip memory arrays, for example SRAM (Static RAM) or Flash, the data could be scrambled using crypt algorithms when write access is performed or unscrambled/decrypt when read. Methods of protecting such memory content are typically dedicated to memory arrays because the methods are too complex in terms of gate count to be applied to sequential elements of pre-characterized cell types (typically configuration registers of peripherals or digital filter status/result/parameter variables). Moreover, memory array content is not subject to download by scan test methods whereas sequential cells of pre-characterized type are subject to download by scan test methods.

FIG. 1 is schematic illustrating a prior art simplified microcontroller and scan chain system. Microcontroller 100 includes microprocessor 102 coupled to memory 104. Address decoder 106 receives and decodes addresses from microprocessor 102 for memory 104 and peripherals 108. Address decoder 106 and peripherals 108 receive addresses on address bus 110 while address decoder 106 transmits select information on memory select 112 and peripheral select 114. Data is transmitted between microprocessor 102, memory 104, and peripherals 108 on data bus 116. A read or a write signal is transmitted between microprocessor 102 and memory 104 and peripherals 108 on read/write signal 117. Microcontroller 100 receives clock signal 118 and reset signal 120. Input 122 includes, for example, timer triggers and Universal Asynchronous Receiver/Transmitter(UART) input data while output 124 includes, for example, UART transmitter output data.

Peripherals 108 may be functional logic, for example UART, crypto-processing, digital signal processing (DSP), and digital filtering.

Scan chain system 126 connects to microcontroller 100. Dashed lines are used in the Figures to illustrate the path of signals related to scan chain system 126, while solid lines represent the path of signals following non-scan chain circuitry. Microcontroller 100 receives a scan chain control signal on scan chain control 128 and data on scan chain input 130. Microcontroller 100 transmits data to scan chain system 126 on scan chain output 132. Within microcontroller 100, microprocessor 102 transmits control and data information on scan chain 134 to peripherals 108. Output from scan chain input determines whether peripherals 108 have fabrication defects.

FIG. 2 is a schematic illustrating a more detailed, prior art example of peripheral 108 from FIG. 1. In FIG. 2, peripheral 108 includes address sub-decoder 200, configuration register 202, and processing logic 204. Inputs to peripheral 108 include peripheral select 114, read/write signal 117, address bus 110, clock 118 and data bus 116. Scan chain control 128 and scan chain input 130 are transmitted to peripheral 108 along scan chain 134 (not shown in FIG. 2, see FIG. 1).

During normal operation, address sub-decoder 200 receives signals from microprocessor 102 and address decoder 106. Address sub-decoder 200 transmits a write enable signal along enable write line 206 to selected multiplexers 208. As a multiplexer receives a write enable signal it selects from input available through data bus 116 and also from a sequential cell, for example a scan D flip-flop (SDFF) 210. Multiplexers 208 transmit received input to their respective SDFFs 210. SDFFs 210 transmit to processing logic 204 when they receive clock signals from clock 118.

A SDFF is a normal DFF with the D input driven by the output of a two-to-one multiplexer (not shown), the multiplexer having inputs SD and D, and a select pin SC (the two-to-one multiplexer is shown as a part of scan DFF 210, with inputs SC, SD and D). The SD input is driven by either scan chain input 130 or output from a preceding scan DFF. For example, SDFF 210-1 receives data at input SD from scan chain input 130, while SDFF 210-2 receives data at input SD from the output of SDFF 210-1. Both SDFF 210 1 and 2 receive scan chain control signals (select signals) at input SC from scan chain control 130.

Microcontroller 100 may be operated normally, storing values in peripherals 108, and then switched to scan mode and the content of registers in peripherals 108 may be read out and analyzed. In scan mode, SDFF 210-2 will transmit its value through scan register output 214 to processing logic 204. Processing logic 204 transfers data from scan register output 214 directly to scan chain output 132 without altering the value. Control signals transfer data from SDFF 210-1 to SDFF 210-2 and then out to scan chain output 132. In this manner, sensitive data loaded into registers, or SDFFs, may be read out using scan methodology.

A system and method of protecting sequential cell, or register content, in systems employing scan chain methodology is needed. The system should protect sensitive data loaded into registers while allowing scan chain testing for functionality.

### BRIEF DESCRIPTION OF THE INVENTION

The system and method described here provides a way to scramble the value of the register without affecting the functionality of the associated logic. A combinatorial network of logic cells is placed in front of the register and acts as a scrambling function not specified in any user datasheet because there is no user functionality associated. The reverse combinatorial function is placed after the register. Therefore, even if register location is known through the scan register chain and its content after regular operation is downloaded, it is more difficult to ascertain the functional meaning of the value for the current application.

The invention reduces the ability to download the content of any sequential cell (register) by means of the most popular test method (scan) without compromising the purpose of scan chain systems.

### BRIEF DESCRIPTION OF THE DRAWING FIGURES

FIG. 1 is a schematic illustrating a prior art simplified microcontroller.

FIG. 2 is a schematic illustrating a more detailed prior art example of a peripheral from FIG. 1.

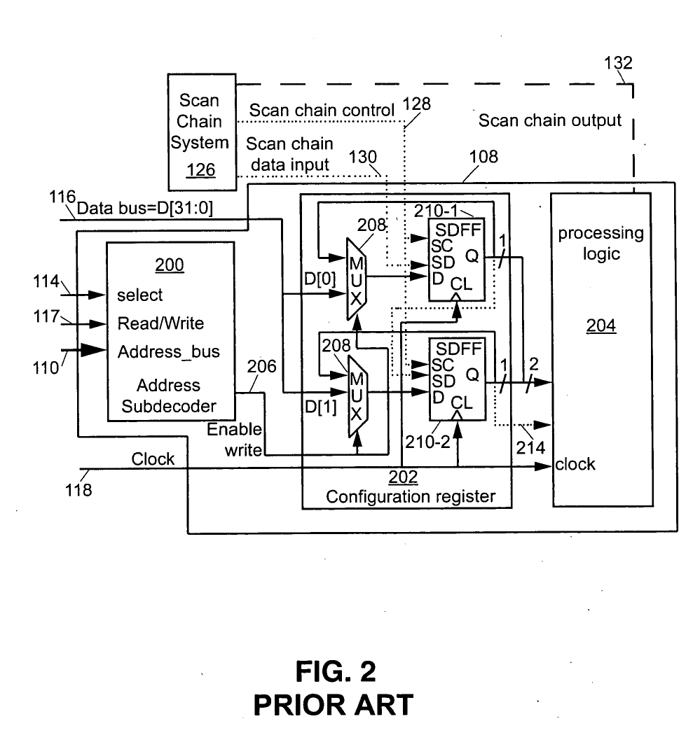

FIG. 3 is a schematic illustrating the invention implemented with a peripheral from FIG. 1.

FIG. 4 is a schematic illustrating one embodiment of the invention using a predetermined scrambling function.

FIG. 5 is a schematic illustrating one embodiment of the invention using a random scrambling function.

FIG. 6 is a schematic illustrating one embodiment of the invention using a random scrambling function.

FIG. 7 is a flow diagram illustrating a method of implementing the invention.

### DETAILED DESCRIPTION OF THE INVENTION

The following description the invention is not intended to limit the scope of the invention to these embodiments, but rather to enable any person skilled in the art to make and use the invention.

The invention may use combinatorial networks to scramble memory cells making this method more convenient for pre-characterized DFFs, or SDFFs, (for example those DFFs within a register) while making sensitive material within the register more secure. Moreover, the invention allows scrambling and unscrambling of the content of a register in one clock cycle, in the case of a combinatorial network. Alternatively, a sequential algorithm in front and after the targeted register may replace the combinatorial networks, though the sequential algorithm may take more than 1 clock cycle to scramble and unscramble the register content.

Protecting content of a register may be achieved by not inserting the DFFs in the scan chain so that the DFFs will not be tested. The invention allows a straightforward test design flow (full scan) without the lack of confidentiality in a scan test. The invention may be used on sequential elements acting as a configuration register in order to protect their content from being easily downloaded.

The scan chain system allows a read-out of the register content while the registers may hold sensitive or confidential data. The invention scrambles the data in the register so that it is difficult to match the value downloaded with the functional value of the application. Few people will know the scrambling method, for example the architect and designer of the circuit. If random or pseudo-random scrambling is used, nobody will know the exact register content from a functional point of view.

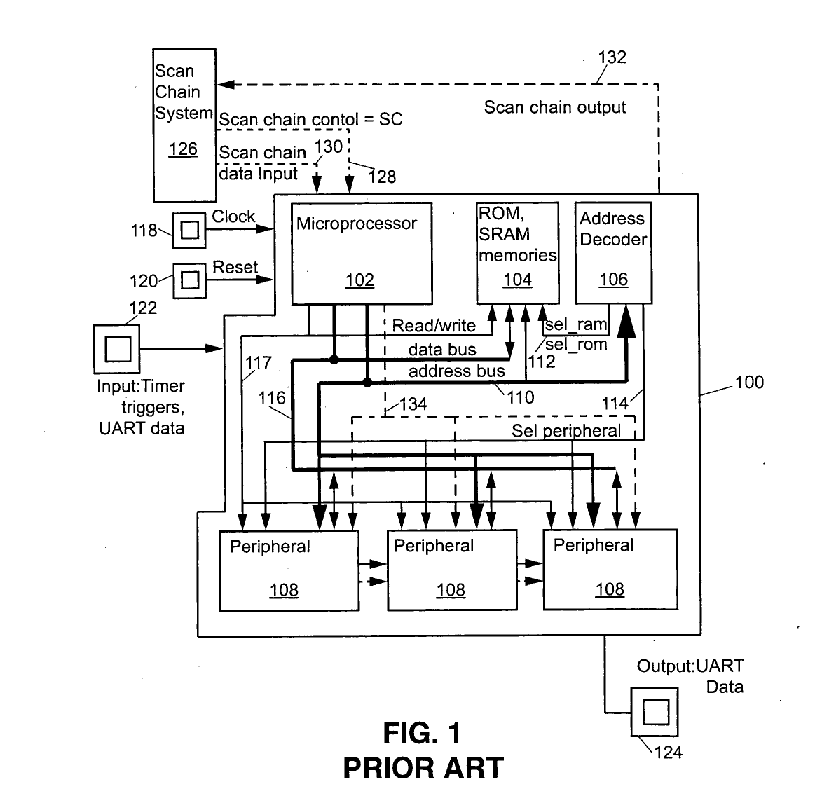

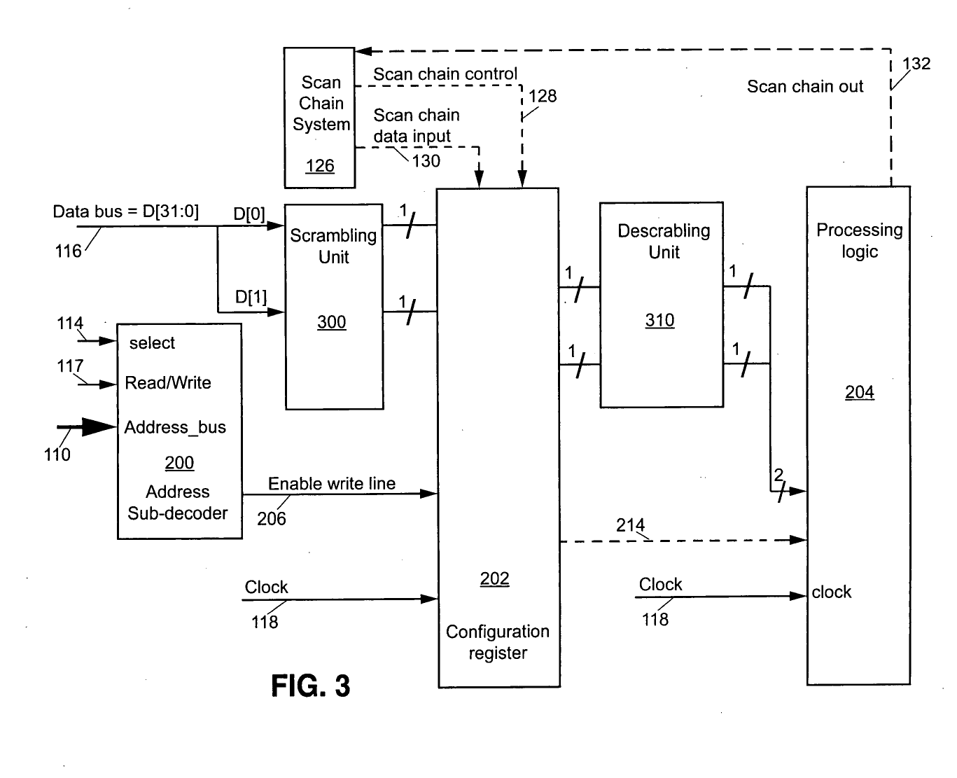

FIG. 3 is a schematic illustrating one embodiment of the invention implemented with a configuration register in a peripheral from FIG. 1. In FIG. 3, address sub-decoder 200 receives peripheral select 114, read/write signal 117, and address bus 110. Address sub-decoder is connected to configuration register 202 by enable write line 206. Configuration register 202 is connected to processing logic by descrambling unit 310.

Scrambling unit 300 is coupled to data bus 116 and configuration register 202. Scrambling unit 300 is configured to receive data, or scrambling unit input, from data bus 116 and to scramble the input in either a predetermined, random, or pseudo-random method. The scrambled data is transmitted to configuration register 202. If normal operations are halted and the register content read out by scan chain system 126, only scrambled data will be transmitted through scan register output 214 and scan chain output 132, protecting register content.

Descrambling unit 310 is coupled to configuration register 202 and is configured to receive the scrambled data from configuration register 202. Descrambling unit 310 is configured to descramble the scrambled data in the reverse manner that scrambling unit 300 scrambled the data. The values output from descrambling unit 310 should be identical to the values input from data bus 116. Although scrambling unit 300 and descrambling unit 310 are shown without a direct connection between them, one skilled in the art will recognize that they may receive/share a random or pseudo-randomly generated value.

In one embodiment, a scrambling function works as follows. A first combinatorial network, scrambling unit 300, uses function F1 and a second combinatorial network, descrambling unit 310, uses function F2. If X is an n-bit (n being an integer) binary coded input from data bus 116, then F1 (X) is the resulting output value of the first combinatorial network.

If the 2 combinatorial networks were connected in series, Y being the output of the first network driving the input of the second network, Z being the output of the second network (Y, X being binary values), then:
Y=F1(X),
Z=F2(Y) and,
Z=F2(F1(X)).

If N is the bit size for X, F1(X) and F2(X), then solving for F1 and F2 by making Z=X yields, for example:
F1(X)=(X+1) mod 2^{N} and
F2(X)=(X-1) mod 2^{N}.
Therefore, Z=F2(F1(X))=F2(X+1)=(X+1)−1=X and Z=X

F1(X), F2(X) may be selected from among various functions including translation tables where each X binary value is coded with another value or F1(X) can be a binary to gray code translator and F2(X) being its reverse function: gray to binary code.

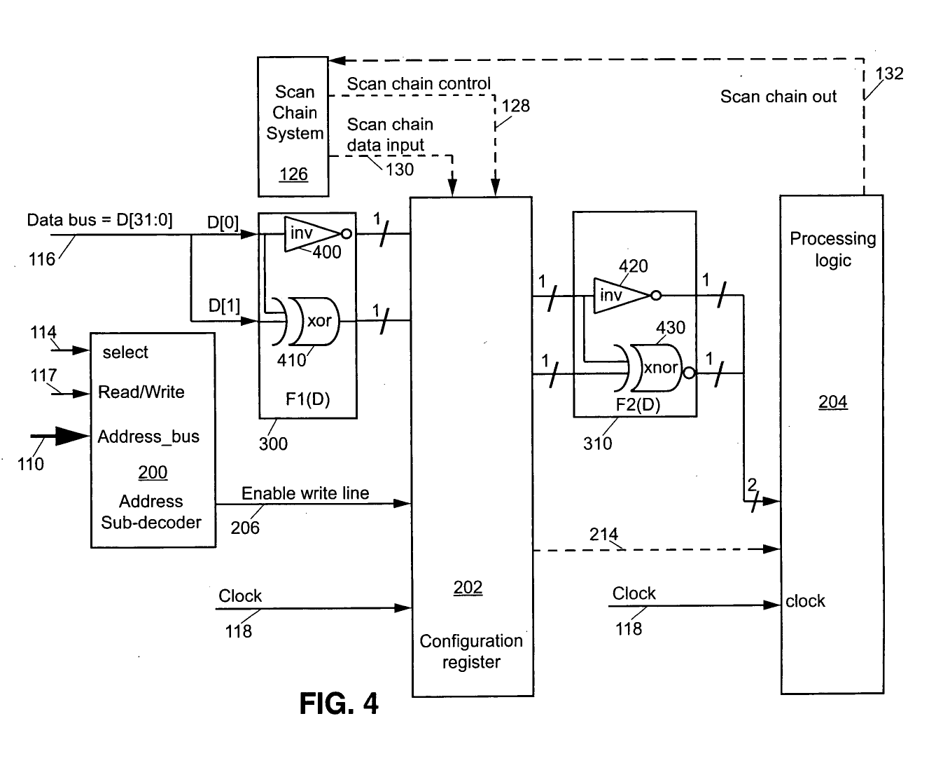

FIG. 4 is a schematic illustrating one embodiment of the invention using a predetermined scrambling function. Scrambling register 300 includes inverter 400 and XOR 410. The mathematical function of inverter 400 and XOR 410 is “+1 modulo 4.” If inputs D[0] and D[1] to scrambling unit 300 are “1” and “1,” respectively, then “11+1 modulo 4” is equal to “00,” is the scrambling unit output of scrambling unit 300. One skilled in the art will recognize that many different functions may be used to scramble and descramble the data, for example “+1 modulo N,” N being any integer.

Processing logic 204 should receive the initial input value of “11,” so inverter 420 and XNOR 430 of descrambling unit 310 produce the mathematical function “−1 modulo 4.” A descrambling unit input of “00” becomes “00-1 modulo 4,” which is equal to “11.” In one embodiment, scrambling unit 300 produces a scrambling unit output that is loaded into configuration register 202 and transmitted to descrambling unit 310, which then produces a descrambled output, all within a single clock cycle.

If configuration register 202 is downloaded by scan chain system 126 then there will be no consistency between the value read and the functional value configured by the application because scan chain system 126 is reading out scrambled input values before descrambling unit 310 has descrambled the values to the original input values from 116.

Although FIG. 4 uses an inverter, XOR and XNOR gates, any combination of logic where X=Z would be appropriate. Additionally, one skilled in the art will recognize that data bus 116 may have a different number of bits and that scrambling unit 300 and descrambling unit 310 could accommodate differently sized data busses.

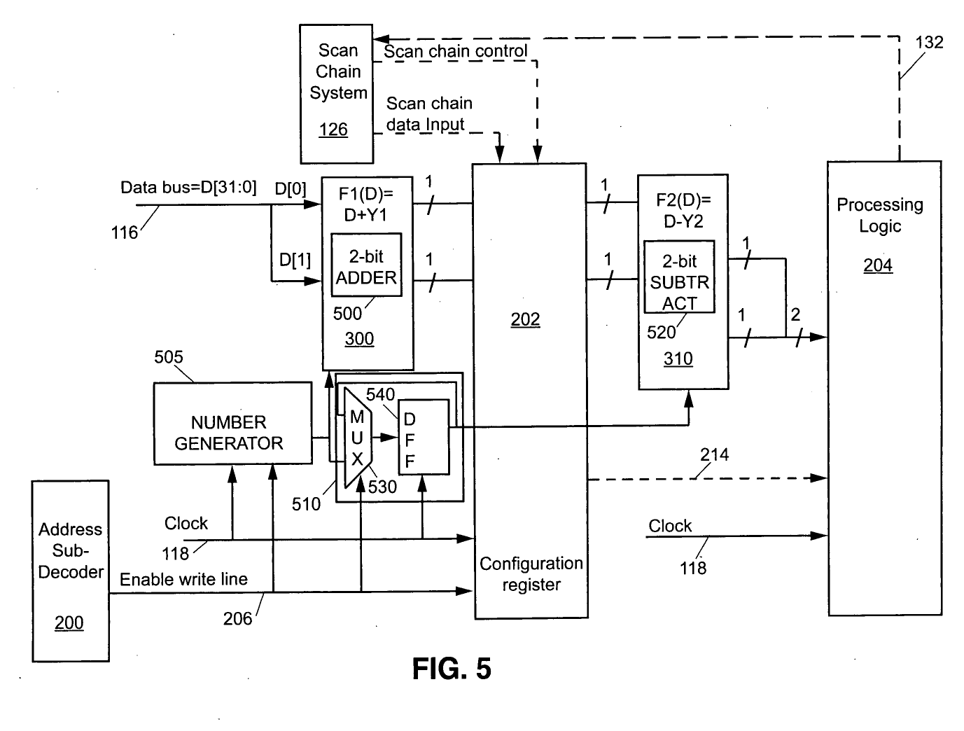

FIG. 5 is a schematic illustrating one embodiment of the invention using a random scrambling function. Scrambling unit 300 comprises, for example two-bit adder 500. Coupled to scrambling unit 300 is a number generator, either random or pseudo-random, for example number generator 505.

Number generator 505 outputs a value to storage unit 510 and scrambling unit 300. Scrambling unit 300 receives the output from number generator 505 and adder 500 adds that number to a two-bit value received from data bus 116. The resulting sum is then transmitted to configuration register 202. For example, if number generator 505 produces the binary value “01,” and scrambling unit 300 receives “11” at its D[0] and D[1] inputs, then the resulting sum is “00.” “00” is the binary value transmitted to configuration register 202.

Storage unit 510 saves the value output from number generator 505 so that whenever new data is written from data bus 116, a signal from write enable line 206 instructs storage unit 510 to output the new value, otherwise storage unit 510 outputs the last value used in scrambling unit 300.

Descrambling unit 310 receives from storage unit the binary value transmitted from number generator 505 to storage unit 510 during a given clock cycle. Continuing with the above example, configuration register 202, after receiving the value “00” from scrambling unit 300, transfers the value “00” to descrambling unit 310. Descrambling unit 310 comprises two-bit subtractor 520, therefore descrambling unit 310 subtracts the value “01” from “00.” The value “01” was generated by number generator 505 and stored in storage unit 510 during the same clock cycle that descrambling unit 310 receives the value “00.” The result is “11,” which is the original value output from data bus 116 at the beginning of the clock cycle.

In one embodiment, storage unit 510 comprises multiplexer 530 and DFF 540.

The content of configuration register 202 changes whenever it is being written to by data bus 116. In the next embodiment, the content of configuration register 202 changes every clock cycle, regardless of whether or not it is being written to.

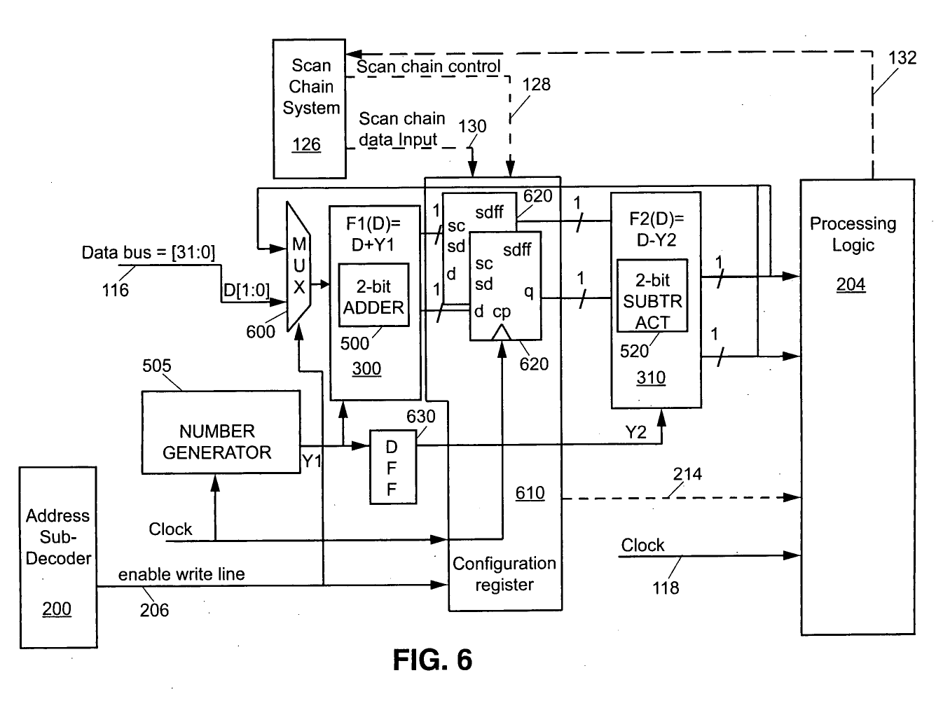

FIG. 6 is a schematic illustrating one embodiment of the invention using a random scrambling function. During normal operation, data bus 116 transfers data to multiplexer 600. Multiplexer 600 receives a write-enable signal from enable write line 206 and transmits the data received from data bus 116 to scrambling unit 300. Scrambling unit 300 receives a random or pseudo-random number from number generator 505 and adds that number to the data received from multiplexer 600 with adder 500. In this example the number is a two-bit binary number. The resulting scrambled number is transmitted to configuration register 610. Configuration register 610 loads one bit of each of the two-bit scrambled number into one of each of SDFF.

DFF 630 also receives the random or pseudo-random number from number generator 505 and in the same clock cycle during which DFF 630 received the number, DFF 630 transmits the number to descrambling unit 310. Descrambling unit 310 receives the random or pseudo-random number from DFF 630 and it receives the scrambled content from SDFFs 620. Descrambling unit subtracts the random or pseudo-random number from the scrambled number using subtractor 525. Descrambling unit 310 outputs the descrambled value to processing logic 204 and to multiplexer 600.

During a clock cycle in which there is no “write” operation from data bus 116 to multiplexer 600, multiplexer 600 receives only descrambled output from descrambling unit 310. With no write-enable signal from enable write line 206, multiplexer 600 selects the descrambled output and transmits it to scrambling unit 300. Scrambling unit 300 receives a random or pseudo-random number from number generator 505 and the descrambled output, adds them and loads them into SDFFs 620. The effect of this is to rescramble with a new number, each clock cycle, the descrambled output from descrambling unit 310.

One skilled in the art will recognize that number generator 505 could be another configuration register, a configurable register that is not part of scan chain system 126, the output of a finite state machine status flag, interrupt flag, or any other random or determinable value generator. Sensitive or confidential material loaded into configuration register 610 is more difficult to recover due to a variable and continuous scrambling function.

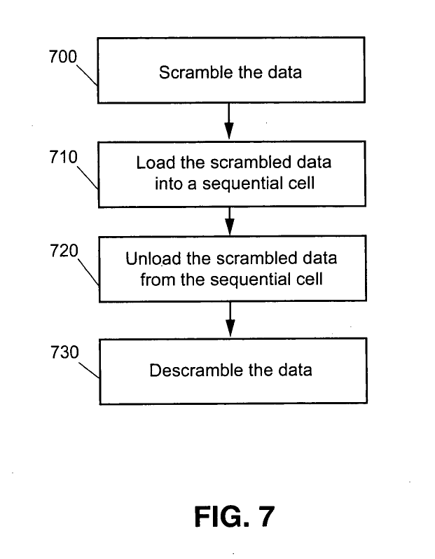

FIG. 7 is a flow diagram illustrating a method of scrambling sequential cell content in an integrated circuit. In block 700, scramble the data. In block 710, load the scrambled data into a sequential cell. In block 720, unload the scrambled data from the sequential cell. In block 730, descramble the data.

One advantage of the invention is that the combinatorial networks used to scramble and descramble the register have a low gate count, allowing them to more easily fit on an IC and keep its cost down.

As any person skilled in the art will recognize from the previous description and from the figures and claims that modifications and changes can be made to the invention without departing from the scope of the invention defined in the following claims.

1. A system for scrambling data in a sequential cell, the sequential cell configured to receive the data from a data bus, comprising:
a scrambling unit coupled to the sequential cell and the data bus, the scrambling unit configured to receive a scrambling unit input from the data bus and produce a scrambling unit output that differs from the scrambling unit input, wherein the scrambling unit output is transmitted to the sequential cell; and
a descrambling unit coupled to the sequential cell and configured to receive a descrambling unit input from the sequential cell and produce a descrambling unit output that differs from the descrambling unit input, wherein the descrambling unit output is equal to the scrambling unit input.

2. The system of claim 1, wherein the sequential cell comprises a D flip-flop.

3. The system of claim 1, wherein the sequential cell is a configuration register.

4. The system of claim 1, wherein the scrambling unit is configured to produce the scrambling unit output using a random value.

5. The system of claim 1, wherein the scrambling unit produces the scrambling unit output by manipulating the scrambling unit input with a scrambling operation: +1 modulo N, N being an integer.

6. The system of claim 5, wherein the scrambling unit further comprises an inverter and an XOR gate.

7. The system of claim 5, wherein the descrambling unit produces the descrambling unit output by manipulating the descrambling unit input with a descrambling operation: −1 modulo N, N being an integer.

8. The system of claim 7, wherein the descrambling unit further comprises an inverter and an XNOR gate.

9. The system of claim 1, wherein the scrambling unit produces the scrambling unit output by manipulating the scrambling unit input with a scrambling function and the descrambling unit produces the descrambling unit output by manipulating the descrambling unit input with a descrambling function, wherein the descrambling unit function is the inverse of the scrambling unit function.

10. The system of claim 9, wherein the scrambling unit receives a number, the scrambling function configured to manipulate the scrambling unit input with the number.

11. The system of claim 10, wherein the descrambling unit receives the number, the descrambling function configured to manipulate the descrambling unit input with the number.

12. The system of claim 11, further comprising:
a number generator configured to generate the number; and
a storage unit configured to store the number for the descrambling unit.

13. The system of claim 12, wherein the number generator is a random sequence generator.

14. The system of claim 12, wherein the storage unit is a multiplexer coupled to a D flip-flop.

15. The system of claim 12, wherein the sequential cell receives a clock signal and is configured to receive data at intervals defined by the clock signal, wherein the storage unit and the number generator receive the clock signal and the scrambling unit is configured to transmit scrambling unit output to the sequential cell at intervals defined by the clock signal and a receipt of data.

16. The system of claim 11, wherein the scrambling unit further comprises:
a means for multiplexing configured to receive the scrambling unit input and the descrambling unit output

17. The system of claim 16, further comprising:
a number generator configured to generate the number; and
a storage unit configured to store the number for the descrambling unit.

18. The system of claim 17, wherein the number generator is a random sequence generator.

19. The system of claim 17, wherein the storage unit is a D flip-flop.

20. The system of claim 17, further comprising:
a means for directing output from the descrambling unit to the input of the scrambling unit, wherein the sequential cell receives a clock signal and is configured to receive data at intervals defined by the clock signal, wherein the storage unit and the number generator receive the clock signal and the scrambling unit is configured to transmit scrambling unit output to the sequential cell at intervals defined by the clock signal, the scrambling unit using the descrambling unit output as scrambling unit input if there is no scrambling unit input from the data bus.

21. The system of claim 20, wherein the means for directing output from the descrambling unit to the input of the scrambling unit is a multiplexer.

22. A microcontroller having a sequential cell configured to receive data from a data bus, a system for scrambling the data in the sequential cell comprising:
a scrambling unit coupled to the sequential cell and the data bus, the scrambling unit configured to receive a scrambling unit input from the data bus and produce a scrambling unit output that differs from the scrambling unit input, wherein the scrambling unit output is transmitted to the sequential cell; and
a descrambling unit coupled to the register and configured to receive a descrambling unit input from the sequential cell and produce a descrambling unit output that differs from the descrambling unit input, wherein the descrambling unit output is equal to the scrambling unit input.

23. The microcontroller of claim 22, further comprising a peripheral module coupled to the microcontroller, wherein the sequential cell is a configuration register in the peripheral module.

24. The microcontroller of claim 22, wherein the sequential cell is storing a parameter of a digital signal processing algorithm.

25. The microcontroller of claim 22, wherein the sequential cell is a key of a crypt algorithm.

26. The microcontroller of claim 22, wherein the sequential cell is a temporary value of the system bus.

27. A microcomputer having a register, the register configured to receive data from a data bus, a system for scrambling the data in the register comprising:
a scrambling unit coupled to the register and the data bus, the scrambling unit configured to receive a scrambling unit input from the data bus and produce a scrambling unit output that differs from the scrambling unit input, wherein the scrambling unit output is transmitted to the register; and
a descrambling unit coupled to the register and configured to receive a descrambling unit input from the sequential cell and produce a descrambling unit output that differs from the descrambling unit input, wherein the descrambling unit output is equal to the scrambling unit input.

28. A method of scrambling sequential cell content in an integrated circuit, comprising:
scrambling data;
loading the scrambled data into a sequential cell;
unloading the scrambled data from the sequential cell; and
descrambling the data.

29. The method of claim 28, wherein the sequential cell is a register and the integrated circuit is a microcontroller.

30. The method of claim 28, wherein scrambling comprises:
performing the mathematical function “+1 modulo N” on the data, N being an integer.

31. The method of claim 28, further comprising:
generating a number; and
wherein scrambling the data further comprises manipulating the data with the number.

32. The method of claim 31, wherein loading the scrambled data into a sequential cell occurs each clock cycle.

33. The method of claim 31, wherein loading the scrambled data into a sequential cell occurs each clock cycle during which there is new data to be scrambled.
